(19) United States
(12) Patent Application Publication
(10) Pub. No.: US 2008/0082230 A1
(43) Pub. Date: Apr. 3, 2008

(54) Process for estimating operational availability of a system

(76) Inventors: David F. Harvey, Melbourne, FL (US); Thomas T. Collipi, Melbourne, FL (US)

Correspondence Address: LOUIS L. DACHS, 5782 CALPINE DRIVE, MALIBU, CA, 90265, US

(21) Appl. No.: 11/541,936

(22) Filed: Oct. 2, 2006

(51) Int. Cl. G01M 17/00; G06F 19/00

(52) U.S. Cl. 701/29

(57) ABSTRACT

The invention is a process for determining the operational availability of a system and includes the following steps: 1) selecting values for flight hours per year, repair concurrency, annual preventative maintenance time and non mission capable-supply rate; 2) calculating the effects of usage rate, repair concurrency, and not mission capable-supply; and 3) calculating the operational availability of the aircraft based on the calculation of the effects of usage rate, repair concurrency, and not mission capable-supply.

### BACKGROUND OF THE INVENTION

1. Field of the Invention

The invention relates to the field of logistics support procedures for aircraft and the like and, in particular, to a process for determining the operation availability of a system, such as an aircraft, in the design and development phase.

2. Description of Related Art

Operational suitability terminology and definitions to be used in operational test and evaluation operational availability (Aₒ) is typically defined as:

Ao=Total Time System Is Operational/(Total Calendar Time Possessed)

### Where:

### Total Time System Is In Operation=Mission Capable Hours (MC)

### MC—Mission Capable Hours

### MC Hours=FMC Hours+PMC Hours.

### FMC—Fully Mission Capable Hours

### PMC—Partially Mission Capable Hours

### Thus:

Ao=MC Hours/(Hours Possessed)

But hours possessed includes MC+Total Down Time. Therefore:

Ao=MC Hours Hours/(MC Hours+Total Down Time)

Air Force Instruction Equipment Inventory, Status, And Utilization Reporting (AFI) 21-103 defines the defines the approach to collecting and recording Equipment Status. The operator documents the calendar time (Hours) that the aircraft is FMC, PMC, and NMC (Non Mission Capable}, which includes: non mission capable due to maintenance (NMCM) and non mission capable due to supply (NMCS). The user does not collect the data, but only records actual aircraft status. It is desirable to have a process to predict Ao during the design and development of the aircraft based upon performance of similar aircraft and the performance major systems being developed for use thereon.

Thus, it is a primary object of the invention to provide a process for determining operational availability of a system such as an aircraft.

It is another primary object of the invention to provide a process for determining operational availability of a system such as an aircraft during the development stage.

It is a further object of the invention to provide a process for determining operational availability of a system such as an aircraft during the development stage, which allows trade studies to be conducted to maximize potential operational availability.

### SUMMARY OF THE INVENTION

The invention is a process that allows the designer of a system to input values for mean time to repair and mean time between failures using traditional reliability and maintainability analysis techniques, and to predict their effect on operational availability. This bridges the gap between parameters which are under design control (mean time to repair and mean time between failure) and those which are not (for example mission capable rate). It does this by combining the effects of usage rate, repair concurrency, and not mission capable-supply rates. By doing so, it allows the designer to experiment with utilization rates and support concepts to find total system support alternatives that meet the customer's mission operational availability requirements.

In general, the process for determining the operational availability of a system includes the following process:

### 1. Selecting values for flight hours per year, repair concurrency, annual preventative maintenance time and non mission capable-supply rate.

### 2. Calculating the effects of usage rate, repair concurrency, and not mission capable-supply; and

### 3. Calculating the operational availability of the aircraft based on the calculation of the effects of usage rate, repair concurrency, and not mission capable-supply.

In more detail, the process can be further divided into 13 steps:

### 1. Determine annual aircraft usage.

### 2. Determine Number Of Sorties Per Year

### 3. Determine Failures Per Year

### 4. Determine Failures Per Sortie

### 5. Determine Repair Time Per Sortie

### 6. Determine The Elapsed Repair Time Per Sortie

### 7. Determine Annual Elapsed Repair Time

### 8 Determine Annual Preventative Maintenance Time Per Year

### 9 Determine Annual Total Not Mission Capable Maintenance Hours per year

### 10. Determine Annual Total Not Mission Capable Supply Hours

### 11. Determine Annual Total Down time

### 12. Determine Uptime Per Year

### 13. Determine Operational Availability

The novel features which are believed to be characteristic of the invention, both as to its organization and method of operation, together with further objects and advantages thereof, will be better understood from the following description in connection with the accompanying drawings in which the presently preferred embodiment of the invention is illustrated by way of example. It is to be expressly understood, however, that the drawings are for purposes of illustration and description only and are not intended as a definition of the limits of the invention.

### BRIEF DESCRIPTION OF THE DRAWINGS

FIG. 1 is a flow chart of the process.

FIGS. 2A and 2B are a spread sheet illustrating the calculations used by the process to estimate operational availability.

FIG. 3 is a table of typical maintenance schedule for an aircraft.

FIG. 4 is graph, which illustrates sensitivity to annual use and aircraft MTBF. The graph, based on data generated by the process, plots operational availability as a function of two variables: reliability and usage.

FIG. 5 is a graph, which illustrates the sensitivity to annual use and repair concurrency. The graph, based on data generated by the process, shows operational availability as a function of two variables: usage rate and repair concurrency.

FIG. 6 is a graph, which illustrates the sensitivity to aircraft mean time between failures (MTBF) and mean time to repair (MTTR). The graph, also based on data generated by the process, shows operational availability as a function of two variables: MTBF and MTTR.

### DESCRIPTION OF THE PREFERRED EMBODIMENT

The process allows the designer of the system to input values for mean time to repair (MTTR) and mean time between failure (MTBF) using traditional reliability and maintainability analysis techniques, and to predict their effect on operational availability (Ao). This bridges the gap between parameters which are under design control (MTBF and MTTR), and those which are not (for example, MC rate). It does this by combining the effects of usage rate, repair concurrency, and not mission capable-supply (NMCS). By doing so, it allows the designer to experiment with utilization rates and support concepts to find total system support alternatives that meet the customer's Ao requirements. For purposes of illustration only, an aircraft will be used as an example of the system.

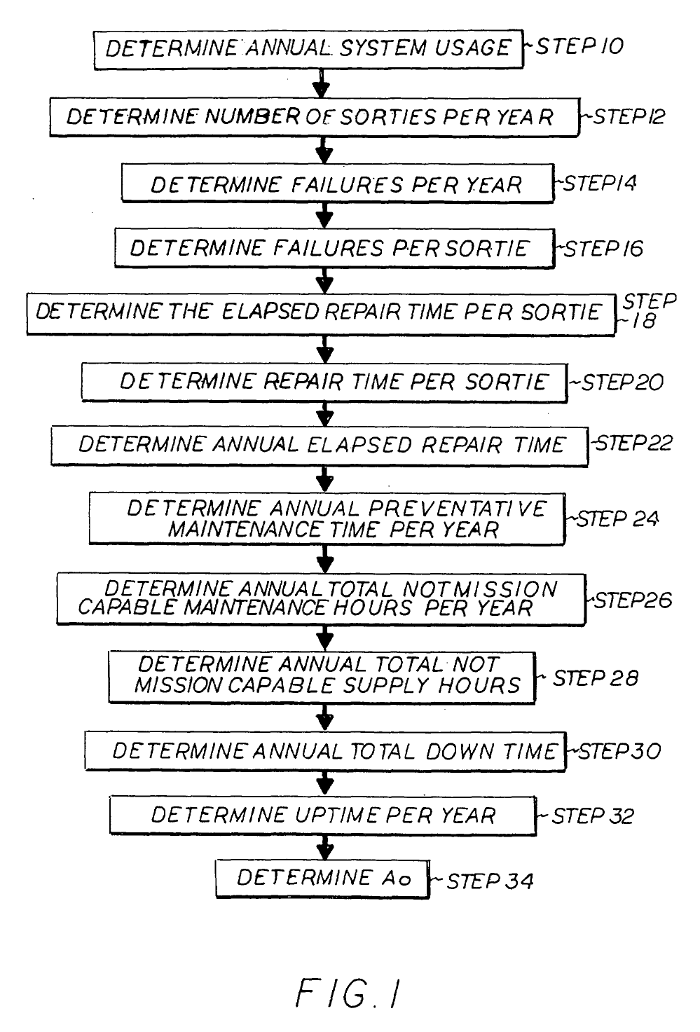

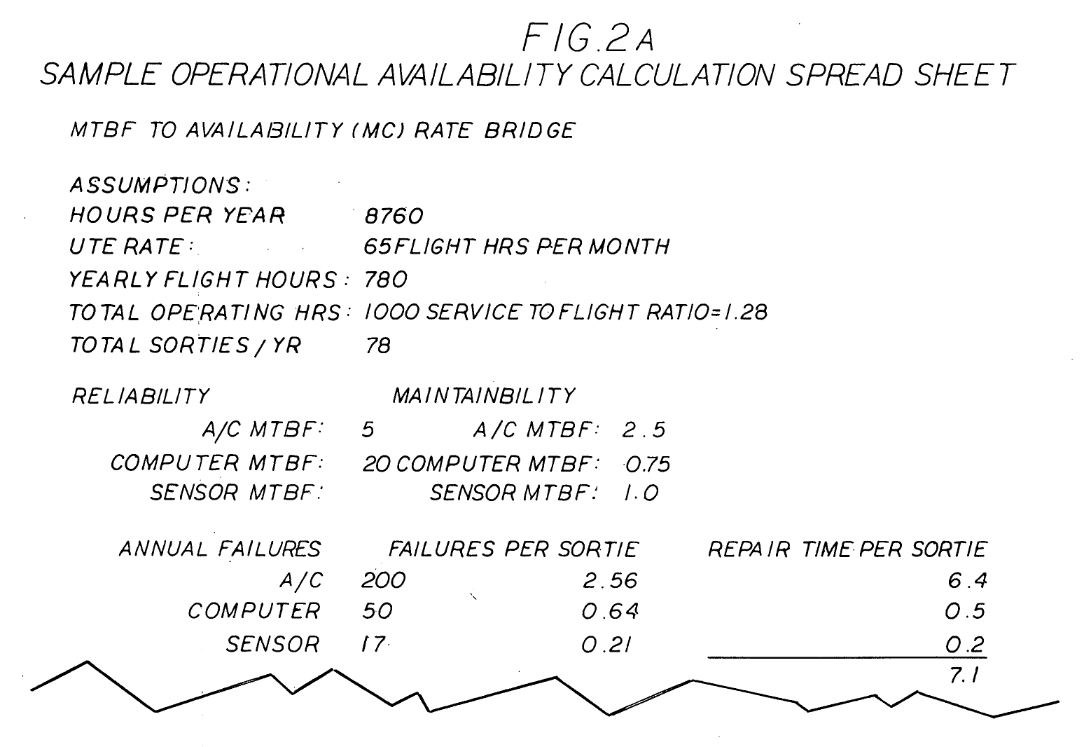

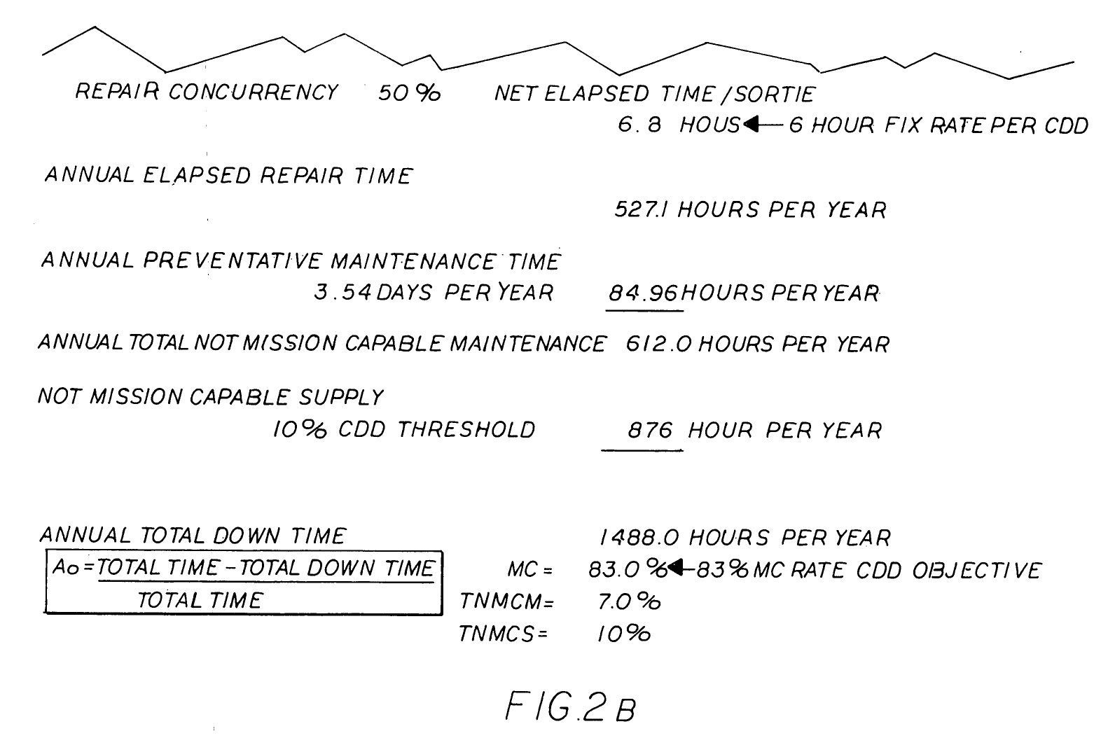

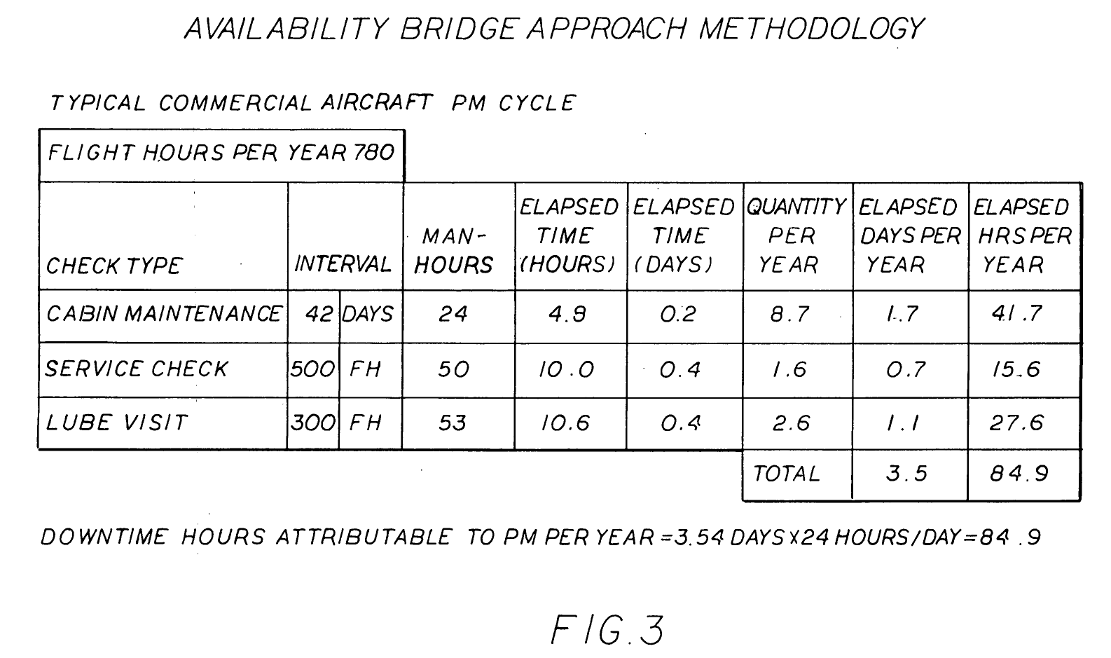

Referring to FIGS. 1, 2A and 2B, the major variables are:

### 1. Flight hours per Year

### 2. Repair Concurrency

### 3. Annual Preventative Maintenance Time

### 4. NMCS Rate

It will be seen that some of the values are: 1) assumed, based on similar aircraft, or 2) based on major systems under development where a preliminary values have been obtained.

Following are the steps in the bridging process.

Step 10—Determine Annual system Usage. For purposes of illustration, it is assumed that the system flies 65 hours per month (FH/Mo.) or 780 flight hours per year (FH/Yr.). However, the system is in operation on the ground, which includes warm up, taxing before takeoff and after landing. There are also holds due other aircraft taking off and landing. A ratio of 1.28 operational hours per flight hour is used. Therefore:

780 FH/Yr×1.28=1000 Operating Hours/Yr.

Step 12 Determine Number Of Sorties Per Year. For purposes of illustration a sortie lasts 10 flight hours. The desired length of a sortie is normally determined by the customer specification for the system under development.

780 FH/Yr/10 FH/Sortie=78 Sorties Per Year

Step 14 Determine Failures Per Year.

Here three systems are considered: the aircraft itself (AC), aircraft sensor (AS), and computer system (CS).
The AC it assumed to have a MTBF of 5 Hours, the AS 20 Hours, and the CS 60 hours: These assumed values could be based on: actual systems or ones under development, which have sufficient test data. Thus with a 1000 operating hours per year the three systems will have:

AC will have 1000 Operating Hours/5=200 failure per year

AS will have 1000/20=50 failures per year

CS will have 1000/60=16 failures per year

Step 16 Determine Failures Per Sortie.

For the AC, 200 AC Fail./yr/78 Sorties/yr=2.56 AC Failures/Sortie.

For the AS, 50 Fail./yr/78 Sorties/yr=0.64 AS Failures/Sortie

For the CS, 16 Fail./yr/78 Sorties/yr=0.2 CS Failures/Sortie

Assume AC MTTR of 2.5, therefore, 2.5×256=6.4 hrs/sortie

But MTTR×Failures/sortie=Hours to repair/sortie

AC MTTR=2.5, thus 2.5×2.56=6.4 hrs/sortie

AS MTTR=0.75, thus 0.75×0.64=0.5 hrs/sortie

CS MTTR=1.0, thus 1.0×0.021=0.2 hrs/sortie

Total Repair Time/Sortie=7.1 hrs/sortie

Step 18 Determine The Elapsed Repair Time per Sortie. Elapsed time to repair depends upon percent of repairs that occurs simultaneously (Repair Concurrency (RC) %):

### At 0% RC Elapsed Time To Repair=Total of All Repair Times=7.1 hrs

### At 100% RC Elapsed Time To Repair=Time Of Longest Repair=2.5 hrs

Step 20 Determine Repair Time Per Sortie

Assuming A Linear Distribution, Repair Time is Determined by:

Elapsed Time=6.4−(6.4−7.1)×(1−RC%)hrs/sortie

### At 50% Repair Concurrency, Elapsed Repair Time per Sortie=6.8 hrs.

Step 22 Determine Annual Elapsed Repair Time

6.8 hrs/sortie×78 sorties/yr=527.1 hrs/yr.

Step 24 Determine Annual Preventative Maintenance Time Per Year Note that this does not include preventive depot maintenance (PDM) or preventive maintenance (PM) that can be performed In 2 hours or less. Thus annual preventive maintenance is both calendar and flight hour based. A typical preventive maintenance schedule for a commercial passenger transport is presented in FIG. 2. It can be seen that downtime due to PM per year is 3.54 days×24 hours per day=84.96 hours.

Step 26 Determine Annual Total Not Mission Capable Maintenance Hours Per Year

| | |
|---|---|
| Annual elapsed repair time = | 527.1 hrs/yr |
| Annual PM maintenance time = | 84.9 hrs/yr |
| Total NMCM hours/yr = | 612.0 hrs/yr |

Step 28 Determine Annual Total Not Mission Capable Supply Hours based on the customer's Capability Description Document (CDD), the threshold value for NMCS is 10%, thus:

Total NMCS/yr=8760 hr/yr×10%=876 hrs/yr.

### Note that NMCS can vary depending upon the customer's requirements.

Step 30 Determine Annual Total Down time

| | | |
|---|---|---|
| Total NMCM hrs/yr = | 612.0 | hrs/yr |
| Total NMCS hrs/yr = | 876.0 | hrs/yr |
| Total Annual Down Time = | 1488.0 | hrs/yr. |

Step 32 Determine Uptime Per Year

Possessed Time=Up Time+Down Time

Up Time=Possessed Time−Down Time

Up Time/yr=8760 hrs/yr−1488.0 hrs/yr=7272.0 hrs/yr.

Step 34 Determine Ao

$$Ao = \frac{( Up Time )}{( Up Time + Down Time )} = \frac{( 7272.0 )}{( 7272.0 + 1488.0 )} = 84.8 \%$$

### With NMCM equaling 7.0% and NMCS equaling=10%

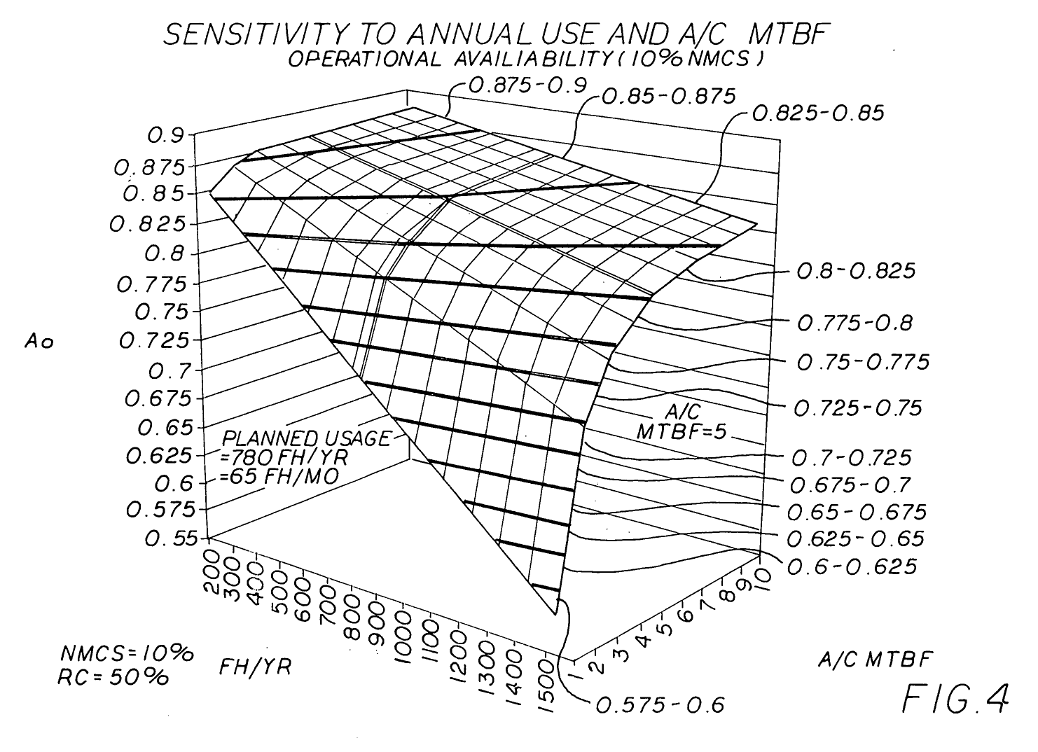

FIG. 4 illustrates sensitivity to annual use and aircraft MTBF. The graph, based on date generated by the process, plots operational availability as a function of two variables: reliability and usage. In particular, the graph shows the operational availability as a function of flight Hours per year (200 to 1500 in 100-hour increments), and overall aircraft MTBF (ranging from 1 to 10 hours between failures in one-hour increments). It uses a 10% NMCS rate. The curved lines on the surface show the intersection of the X-Axis variable (FH/Yr) with the surface. These lines show a family of exponential curves representing availability as a function of MTBF at the different usage rates. The straight lines in the surface show the intersection of the Y-Axis variable (MTBF) with the surface. These lines show a family of straight lines representing availability as a function of usage rate at the different MTBF values. Superimposed on the surface is a pair of lines representing the expected annual usage rate of 780 FH/Yr and the expected aircraft MTBF (5). Their intersection shows that the expected operational availability should be around 0.85.

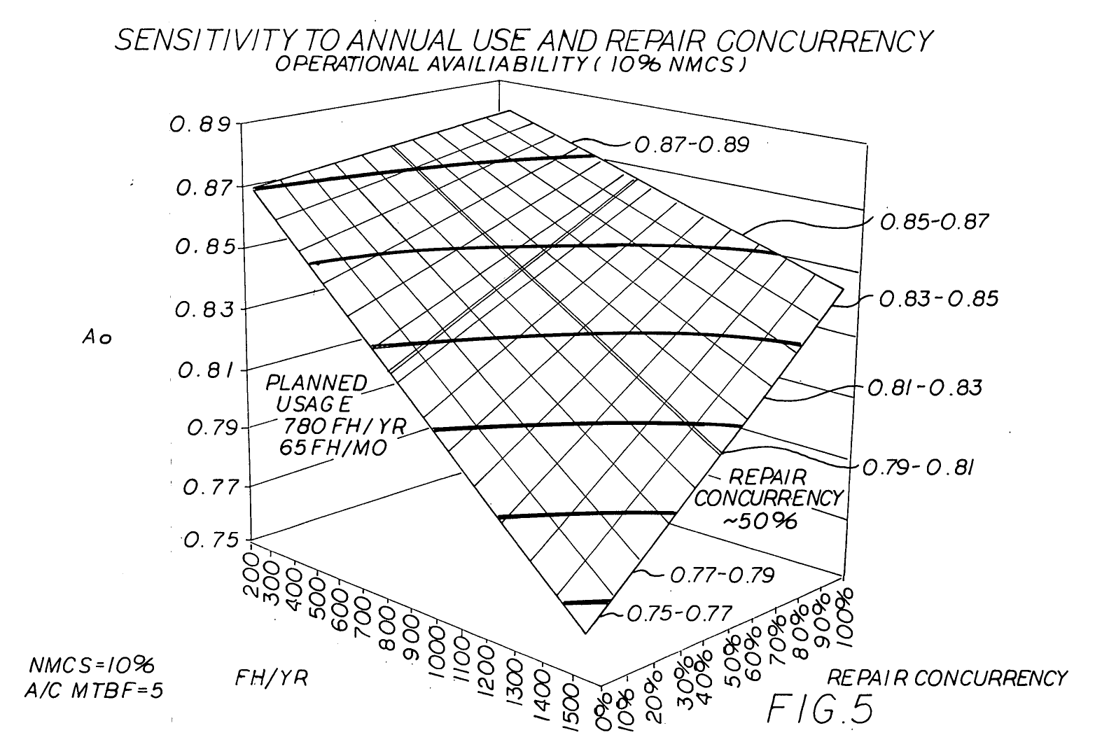

FIG. 5 illustrates the sensitivity to annual use and repair concurrency. The graph, based on data generated by the process, shows operational availability as a function of two variables: usage rate and repair concurrency. The graph shows the operational availability as of function of flight hours per year (200 to 1500 in 100-hour increments) and repair concurrency (0 to 100% in 10% increments) and uses 10% NMCS rate. This graph shows that 17 with 50% repair concurrency at the expected usage rate, the operational 18 availability should be in the 84% range. The graph indicates that there is 19 more sensitivity to repair concurrency at higher usage rates (the lines have a greater slope at higher FH/Yr values).

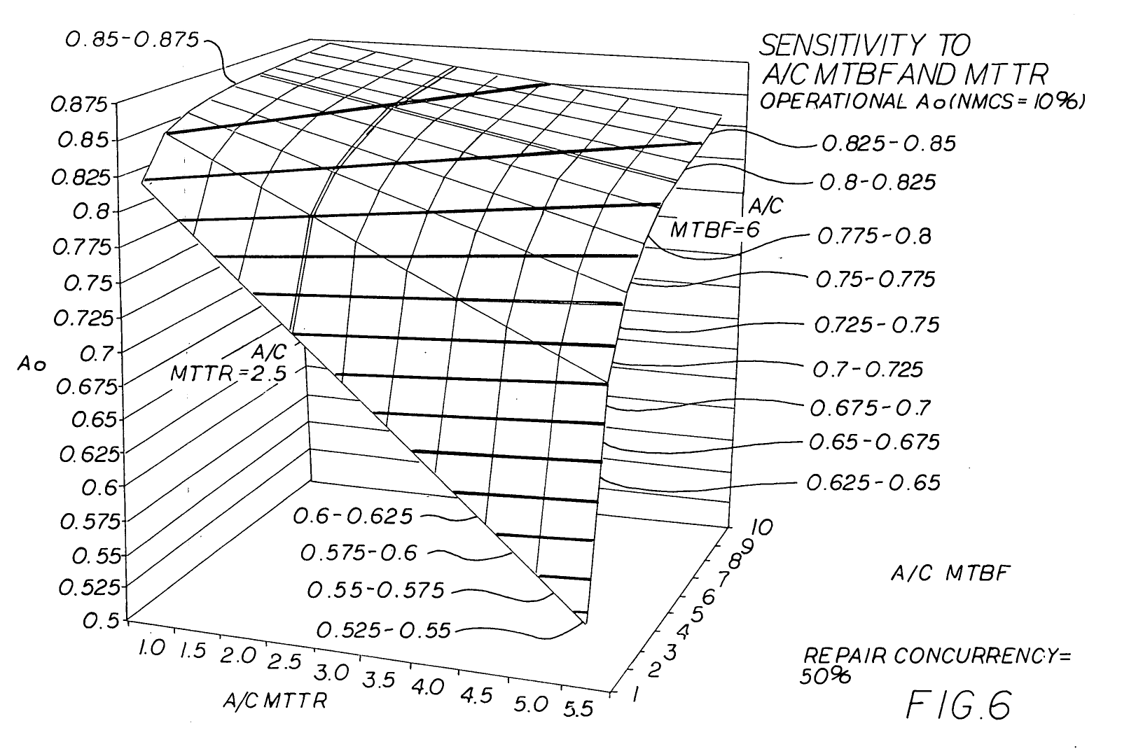

FIG. 6 illustrates the sensitivity to aircraft MTBF and MTTR. The graph, also based on data generated by the process, shows operational availability as a function of two variables: MTBF and MTTR. The MTBF ranges are from 1 to 10 hours and MTTR ranges are from 0.5 to 5.5 hours in 5 in 0.5-hour increments. This graph shows a curved surface representing families of MTTR-MTBF parameters. It shows that with a 6-hour MTBF, to achieve an Availability of around 0.85, it must have an MTTR of about 2.5 hours.

It can now be seen that the process calculates Ao in a fashion similar to AFI 21-103. The process provides conservative results in that it maintains fractions of events (failures and inspections) and does not take into account deferred maintenance. Furthermore, repair concurrency is driven by unit manpower and repair actions preclude other activity. Thus, as previously stated, the process allows the designer to experiment with utilization rates and support concepts to find total system support alternatives that meet the customer's Ao requirements.

While the invention has been described with reference to a particular embodiment, it should be understood that the embodiment is merely illustrative as there are numerous variations and modifications which may be made by those skilled in the art. Thus, the invention is to be construed as being limited only by the spirit and scope of the appended claims.

### INDUSTRIAL APPLICABILITY

The invention has applicability to industries producing vehicles, and particular to the aircraft industry.

1. A process for determining the operational availability of a system, the process comprising the steps of:
Determining Annual System Usage
determining number of sorties per year;
determining failures per year;
determining failures per sortie;
determining repair time per sortie;
determining elapsed repair time per sortie;
determining annual elapsed repair time;
determining annual preventative maintenance time per year;
determining annual total not mission capable maintenance hours per year;
determining annual total time not mission capable supply determining annual total down time determining uptime per year; and
determining operational availability.
A process for determining the operational availability of a system, the process comprising the steps of:
selecting values for flight hours per year, repair concurrency, annual preventative maintenance time and non mission capable-supply rate;
calculating the effects of usage rate, repair concurrency, and not mission capable-supply; and
calculating the operational availability of the aircraft based on the calculation of the effects of usage rate, repair concurrency, and not mission capable-supply.
